(19) United States
(12) Patent Application Publication
(10) Pub. No.: US 2022/0172198 A1
(43) Pub. Date: Jun. 2, 2022

(54) REAL-TIME BLOCKCHAIN SETTLEMENT NETWORK

(71) Applicant: International Business Machines Corporation, Armonk, NY (US)

(72) Inventors: Nitin Gaur, Roundrock, TX (US); Alan Jonathan King, YORKTOWN HEIGHTS, NY (US); Sean Dunne, Mulhuddart (IE); Dulce B. Ponceleon, Palo Alto, CA (US)

(21) Appl. No.: 17/106,074

(22) Filed: Nov. 28, 2020

(51) Int. Cl. G06Q 20/38; G06Q 20/10

(52) U.S. Cl. CPC G06Q 20/385; G06Q 2220/00; G06Q 20/10; G06Q 20/3821

(57) ABSTRACT

An example operation may include one or more of receiving, via a payment network, a request to detokenize a payment token to process a payment transaction between a source and a target, detokenizing the payment token based on mapping data stored in a token vault, transmitting information about the detokenized payment token to a computing device associated with the request, generating a settlement token that comprises identifiers of the source and the target and an identifier of the payment token, and transmitting the settlement token to a blockchain on a blockchain settlement network which is parallel to the payment network.

### BACKGROUND

A centralized platform stores and maintains data in a single location. This location is often a central computer, for example, a cloud computing environment, a web server, a mainframe computer, or the like. Information stored on a centralized platform is typically accessible from multiple different points. Multiple users or client workstations can work simultaneously on the centralized platform, for example, based on a client/server configuration. A centralized platform is easy to manage, maintain, and control, especially for purposes of security because of its single location. Within a centralized platform, data redundancy is minimized as a single storing place of all data also implies that a given set of data only has one primary record.

### SUMMARY

One example embodiment provides an apparatus that includes one or more of a network interface configured to receive, via a payment network, a request to detokenize a payment token to process a payment transaction between a source and a target, and a processor configured to one or more of detokenize the payment token based on mapping data stored in a token vault, transmit information about the detokenized payment token to a computing device associated with the request, generate a settlement token that comprises identifiers of the source and the target and an identifier of the payment token, and transmit the settlement token to a blockchain on a blockchain settlement network which is parallel to the payment network.

Another example embodiment provides a method that includes one or more of receiving, via a payment network, a request to detokenize a payment token to process a payment transaction between a source and a target, detokenizing the payment token based on mapping data stored in a token vault, transmitting information about the detokenized payment token to a computing device associated with the request, generating a settlement token that comprises identifiers of the source and the target and an identifier of the payment token, and transmitting the settlement token to a blockchain on a blockchain settlement network which is parallel to the payment network.

A further example embodiment provides a non-transitory computer-readable medium comprising instructions, that when read by a processor, cause the processor to perform one or more of receiving, via a payment network, a request to detokenize a payment token to process a payment transaction between a source and a target, detokenizing the payment token based on mapping data stored in a token vault, transmitting information about the detokenized payment token to a computing device associated with the request, generating a settlement token that comprises identifiers of the source and the target and an identifier of the payment token, and transmitting the settlement token to a blockchain on a blockchain settlement network which is parallel to the payment network.

### BRIEF DESCRIPTION OF THE DRAWINGS

FIG. 1A is a diagram illustrating a blockchain settlement network according to example embodiments.

FIG. 1B is a diagram illustrating a process of generating a settlement token according to example embodiments.

FIG. 2A is a diagram illustrating an example blockchain architecture configuration, according to example embodiments.

FIG. 2B is a diagram illustrating a blockchain transactional flow among nodes, according to example embodiments.

FIG. 3A is a diagram illustrating a permissioned network, according to example embodiments.

FIG. 3B is a diagram illustrating another permissioned network, according to example embodiments.

FIG. 3C is a diagram illustrating a permissionless network, according to example embodiments.

FIG. 4 is a diagram illustrating a communication process for real-time blockchain settlement of a payment transaction according to example embodiments.

FIG. 5 is a diagram illustrating a method of real-time blockchain settlement of a payment transaction according to example embodiments.

FIG. 6A is a diagram illustrating an example system configured to perform one or more operations described herein, according to example embodiments.

FIG. 6B is a diagram illustrating another example system configured to perform one or more operations described herein, according to example embodiments.

FIG. 6C is a diagram illustrating a further example system configured to utilize a smart contract, according to example embodiments.

FIG. 6D is a diagram illustrating yet another example system configured to utilize a blockchain, according to example embodiments.

FIG. 7A is a diagram illustrating a process of a new block being added to a distributed ledger, according to example embodiments.

FIG. 7B is a diagram illustrating data contents of a new data block, according to example embodiments.

FIG. 7C is a diagram illustrating a blockchain for digital content, according to example embodiments.

FIG. 7D is a diagram illustrating a block which may represent the structure of blocks in the blockchain, according to example embodiments.

FIG. 8A is a diagram illustrating an example blockchain which stores machine learning (artificial intelligence) data, according to example embodiments.

FIG. 8B is a diagram illustrating an example quantum-secure blockchain, according to example embodiments.

FIG. 9 is a diagram illustrating an example system that supports one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Example embodiments provide methods, systems, components, non-transitory computer readable media, devices, and/or networks, which are directed to a blockchain settlement network which runs parallel to a payment network, and which enables a payment transaction to be settled in real-time rather than a traditional overnight settlement process.

In one embodiment this application utilizes a decentralized database (such as a blockchain) that is a distributed storage system, which includes multiple nodes that communicate with each other. The decentralized database includes an append-only immutable data structure resembling a distributed ledger capable of maintaining records between mutually untrusted parties. The untrusted parties are referred to herein as peers or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency. In various embodiments, a permissioned and/or a permissionless blockchain can be used. In a public or permission-less blockchain, anyone can participate without a specific identity. Public blockchains can involve native cryptocurrency and use consensus based on various protocols such as Proof of Work (PoW). On the other hand, a permissioned blockchain database provides secure interactions among a group of entities which share a common goal but which do not fully trust one another, such as businesses that exchange funds, goods, information, and the like.

This application can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincode to specify endorsers for a transaction in the form of a set of peer nodes that are necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

This application can utilize nodes that are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node). Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

This application can utilize a ledger that is a sequenced, tamper-resistant record of all state transitions of a blockchain. State transitions may result from chaincode invocations (i.e., transactions) submitted by participating parties (e.g., client nodes, ordering nodes, endorser nodes, peer nodes, etc.). Each participating party (such as a peer node) can maintain a copy of the ledger. A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain.

This application can utilize a chain that is a transaction log which is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

Tokenization is a process of substituting a non-sensitive data value (token) for a sensitive data value. Tokenization is often used in processing of payment card transactions in which a token service provider (TSP) substitutes payment card data values (e.g., payment account number (PAN), expiry, etc.) with tokens that have no extrinsic or exploitable value. A mapping between the token(s) and its underlying payment data value(s) may be stored in a token vault of the TSP. A token can have a same size and data type as the card value (PAN, expiry, etc.) which it is being substituted for and can be used in the payment network. For example, a token may be used in a payment authorization request message (ISO 8583) from a merchant to a payment network in place of the original payment card number.

The token is not payment enabled. Instead, a detokenization process must be performed to retrieve the original payment information. The detokenization is often performed by the TSP that created the token based on the mapping information that is stored in the token vault. The TSP returns the PAN, expiry, etc. to the payment network to enable the balance/account to be verified with an issuer thereof.

One type of payment tokenization is EMV (Europay, Mastercard, Visa, etc.) tokenization which replaces the PAN with a non-cryptographically reversible token. This process reduces PCI-compliance scope when implemented correctly. To perform tokenization, a customer inputs their PAN online or in-store to a merchant, or more generally, a token requestor. The token requestor sends the PAN and tokenization request to the payment network's tokenization service (e.g., TSP). The TSP sends the request to the issuer of the PAN. With the issuer's approval, the TSP replaces the PAN with a token. The token is sent back to the token requestor and mapping details are stored in a token value associated with the TSP.

The token can be stored within a mobile wallet on the consumer's mobile device and used by the mobile wallet to perform payment transactions with merchants, etc. For example, the user may swipe their mobile wallet within a proximity of a merchant point-of-sale (mPOS) terminal and transmit the token via short-range communication to the mPOS. As another example, the user may submit their token via an e-commerce website, etc. The token may be passed to an acquirer of the merchant and transmitted via the payment network to the TSP for detokenization and payment processing.

A payment token is valuable because it can initiate a transaction just like the original PAN. The security of a payment token derives from the restriction of how a particular payment token may be used. These usage controls are a product of the specifications for EMV payment tokenization and are referred to as token domain restriction controls (TDRCs) For example, a payment token can be restricted to a particular merchant, a particular device, a payment channel, subsequent merchant-initiated transactions, etc. Another characteristic of payment tokenization is the inverse correlation between functionality and security. As the token becomes more restricted, its functionality decreases while the security increases.

One of the drawbacks of the payment process is that the authorization of the transaction between the consumer and the merchant takes place at a first period of time, and the settlement of the payment between the respective banks (source and target) of the consumer and the merchant occurs at a second period of time which is significantly after the first period of time. This process is often referred to as an overnight settlement in which a batch of transactions between the source and the target are settled (usually once per day). A payment processor reconciles the batch of transactions between the two banks, and moves money between the two to account for the transactions. However, the delay between the authorization and the settlement creates opportunities for errors, fraud, intervening transactions, etc.

The example embodiments overcome the drawbacks of the traditional overnight settlement process through a real-time blockchain network settlement. During a detokenization process, a TSP can trigger a parallel (simultaneous) settlement process on a blockchain network that runs in parallel to the payment network. Here, the TSP can generate a settlement token based on transaction details (e.g., an EMV payment token) which maps to the details of the payment token. For example, the settlement token may include a payment token ID, attributes from the detokenization process (e.g., token type, denomination, date/time, etc.) and information about a source financial institution (issuer, wallet provider, etc.) and a target financial institution (acquirer, etc.) associated with the transaction.

Both the source financial institution and the target financial institution may be members of the payment network and at the same time, have membership in the blockchain settlement network. Therefore, when the settlement token is stored on the blockchain network, it acts as a settlement between the source and the target, in real-time. This settlement process does not interfere with the payment process on the payment network, but instead runs in parallel and creates proof of settlement between the two entities. The settlement token may contain transaction details that are ISO 20022 compliant.

Central Bank Digital Currency (CBDC) stands for central bank digital currency. From a money form perspective, CBDC takes cryptocurrency form as a new form of money, whereas the power of money issuance and monetary policies are still in hand of the central bank. CBDC represents the digital form of a fiat currency of a particular nation (or region), and is issued and regulated by the competent monetary authority of the country. Types of CBDC include retail which is targeted to the general public and wholesale which is issued only for financial institutions. There are multiple in-between types that may have characteristics of both retail and wholesale.

A retail CBDC is one that will be issued for the general public. Retail CBDC based on distributed ledger technology (DLT) has the features of anonymity, traceability, continuous availability, and the feasibility of an interest rate application. The retail proposal is relatively popular among central banks in emerging economies, mainly because of the motivation to take the lead in the rapidly emerging fintech industry, to promote financial inclusion by accelerating the shift to a cashless society, and to reduce cash printing and handling costs.

Meanwhile, a wholesale CBDC is for financial institutions that hold reserve deposits with a central bank. It may be used to improve payments and securities settlement efficiency, as well as to reduce counterparty credit and liquidity risks. A value-based wholesale CBDC may replace or complement reserves at the central bank with a restricted-access digital token. A token may be a bearer asset, meaning that during the transaction the sender would transfer value to the receiver, without intermediaries. This is something fundamentally different from many current system in which the central bank debits and credits the accounts without transferring actual values. The wholesale CBDC is seen as the most popular proposal among central banks because of the potential to make existing wholesale financial systems faster, inexpensive, and safer. The Bank of International Settlements MIS) also shares the view that wholesale CBDC could potentially benefit the payments and settlements systems.

Some of the issues with retail CBDC is that each unit will act like a secure digital instrument equivalent to a paper bill, and can be used as a mode of payment, a store of value and a unit of account. Like a paper-based currency note that carries a unique serial number, each CBDC unit will also be distinguishable to prevent imitation. Since it will be a part of the money supply controlled by the central bank, it will work alongside other forms of regulated money, like coins, bills, notes and bonds. CBDC aims to bring in the best of both worlds including the convenience and security of digital form like cryptocurrencies, and the regulated, reserved-backed money circulation of the traditional banking system. The particular central bank or other competent monetary authority of the country will be solely liable for their operations.

In the example embodiments, she blockchain settlement network can be used to facilitate retail CBDC by employing a settlement process on a parallel blockchain settlement network that is provoked/triggered by a payment detokenization process on a payment network. The blockchain settlement network can rely on existing proven and secure technology of EMV payment and tokenization standards which is fairly widespread, widely accepted and POS enabled. Furthermore, the blockchain settlement network can extend DLT-based wholesale CBDC technology that does interbank settlement including netting and grossing options.

Furthermore, the settlement network enables a model that allows for a settlement token to have rich data (e.g. ISO20022 compliant data) stored therein that facilitates interbank settlement via netting or grossing. In particular, a TSP may use a payment token from the payment network to generate transactions in a parallel blockchain settlement network. This process preserves the integrity of retail payment systems i.e. ecosystem responsibilities and governance structure, reduces risk because settlement tokens may only contains obfuscated information that is relevant during detokenization, and decouples the wholesale interbank system from the process intensive retail payment system with exceptional degree of variation in outcome.

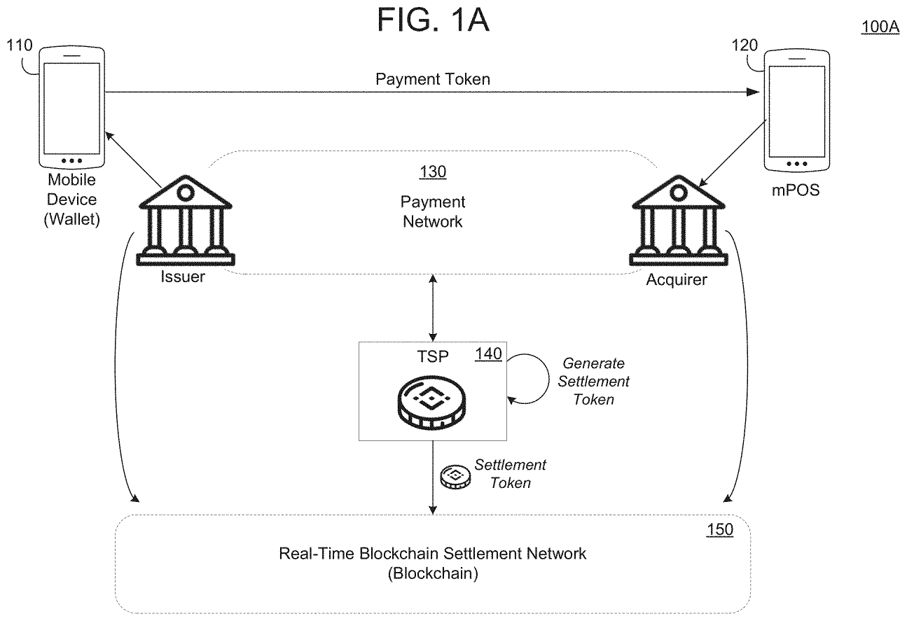

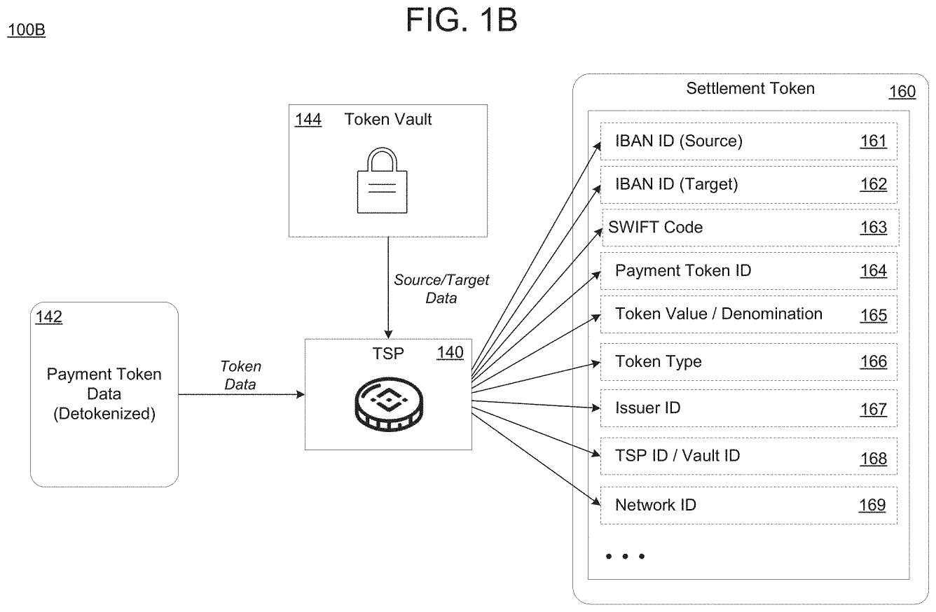

FIG. 1A illustrates a blockchain settlement network 150 that is in parallel with a payment network 130, according to example embodiments. Referring to FIG. 1A, a user/consumer enters into a purchase transaction with a merchant. In this example, the user uses a mobile device 110 to transfer a payment token (e.g., an EMV payment token, etc.) to a merchant point-of-sale (mPOS) terminal 120. For example, the token may be passed by tap/touch such as near-field communication (NFC) between the mobile device 110 and the mPOS 120. As another example, the mobile device 110 may input the token into a web page of an e-commerce site, or the like. Although not shown in FIG. 1A, as another example, the payment token may be stored on a payment card and read by a payment card reader of the mPOS 120. In this case, the token may be extracted from a magnetic stripe or electronic chip of the payment card read by the payment card reader of the mPOS 120.

In this example, the payment token may include a payment account number (PAN) issued by an issuer that has been tokenized into a mobile wallet (digital wallet) application running on the mobile device 110. The tokenization may include a TSP 140 generating a payment token from the PAN (and other details such as expiry, etc.) and providing the payment token to the mobile wallet on the mobile device 110. Although not shown in FIG. 1A, the TSP 140 may store details of the token, including mapping information of a PAN to a token, expiry to a token, etc., in a token vault 144 (shown in FIG. 1B).

When the payment token is received by the mPOS 120, the mPOS 120 may forward the payment token to an acquiring bank of the merchant. In this case, both the issuer of the merchant are participants on a payment network 130 such as a debit or credit network including an automated clearing house (ACH) network, an Accel network, and the like, for the transfer of electronic funds. The issuer and the acquirer may connect to each other and to the TSP 140 via the payment network 130. In particular, the acquirer may forward the payment token to the TSP 140 via the payment network 130 along with a request to detokenize the token. This request may be sent with an authorization request message (ISO 8583).

In response to receiving the detokenization request from the acquirer, the TSP 140 may detokenize the payment token based on mapping information stored in the token vault 144 and forward the detokenized account information to the acquirer. In response, the acquirer may transmit an authorization request message to the issuer to confirm with the issuer that the payment account includes enough funds and there are no other issues. If successful, the issuer may authorize the transaction and transmit an authorization response message to the acquirer. The authorization request message and the authorization response message may be transmitted via the payment network 130, and may satisfy ISO 8583 compliance.

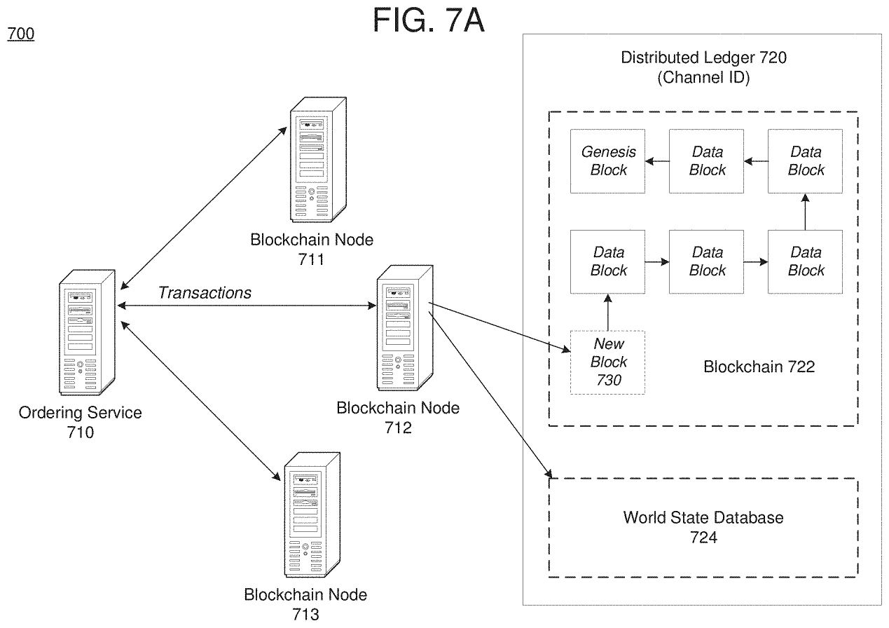

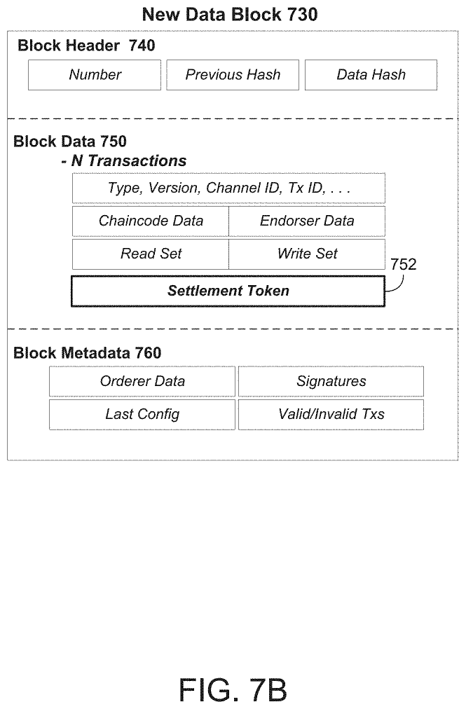

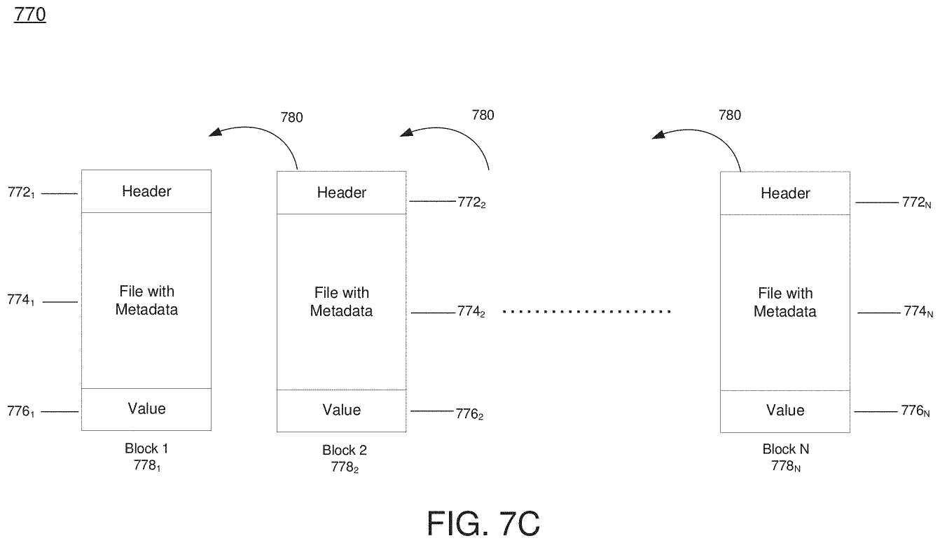

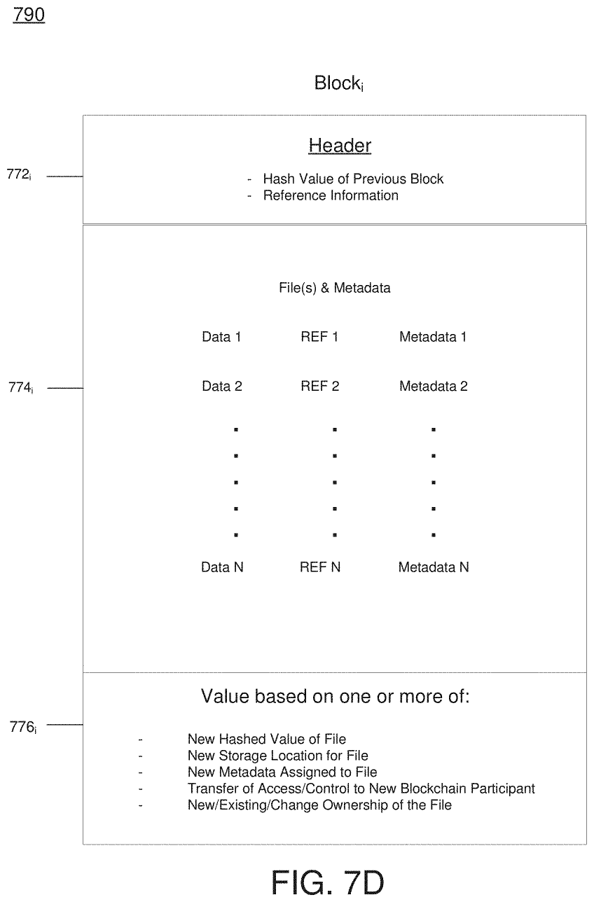

Meanwhile, the TSP 140 may simultaneously launch a real-time settlement of the payment transaction on a blockchain settlement network 150 based on the payment token received via the payment network 130. Here, the TSP 140 may create a settlement token 160 such as shown in FIG. 1B, and submit the settlement token 160 to a blockchain peer of the blockchain settlement network 150. In this example, the issuer (source) and the acquirer (target) are both participants in the blockchain settlement network 150, as well as participants in the payment network 130 which runs in parallel to the blockchain settlement network 150. For example, the source and the target may be clients or even own blockchain peers in the blockchain settlement network 150 and have access to a distributed ledger (blockchain ledger) of the blockchain network 150. FIG. 7B illustrates an example of a data block that may be stored on a blockchain of the distributed ledger of the blockchain settlement network 150.

The blockchain settlement network 150 may include a number of blockchain peers that manage the distributed ledger, and that can interact with the financial institutions. In some embodiments, the financial institutions (e.g., such as the source and the target) may own blockchain peers. As another example, the financial institutions may request access to the ledger as clients from other blockchain peer participants.

Referring to FIGS. 1A and 1B, the TSP 140 may use information from the detokenized payment token 142 and information from the token value 144 to create the settlement token 160. Here, the settlement token 160 may include a file, document, data object, etc., which is based on a template that includes predefined fields. As an example, a bank identifier (IBAN ID) of the source and the target may be mapped to predefined fields 161 and 162, respectively, of the settlement token 160. SWIFT codes of one or more of the source and the target may be mapped to a field 163. A payment token identifier and a token denomination value from the detokenized token data may be mapped to fields 164 and 165, respectively. Likewise, a token type (e.g., credit, debit, etc.) may be mapped to a field 166. Furthermore, an identifier of an issuer of the payment card associated with the token may be mapped to field 167. Furthermore, the TSP 140 may map its identifier and an identifier of its token value to a field 168. Other data elements may be mapped into the settlement token 160, including an identifier of the payment network which may be mapped to a field 169.

When detokenized, the payment token may be in the form of a string that includes a plurality of values concatenated together. In this example, the TSP 140 may parse the string or otherwise extract necessary values out of the string of data and convert the values into values that will meet requirements (size and type) of the predetermined fields of the settlement token 160. For example, the TSP 140 may extract a token identifier (e.g., tokenized PAN) from the detokenized payment token and insert the token identifier into the predefined field 164. Here, the TSP 140 may increase a size or decrease a size of the payment token, change the value from string to Integer, or the like. The same process may be repeated for each of the data values extracted from the detokenized payment data.

Thus, the TSP 140 may extract data from the detokenized payment token 142, and extract data from the token value 144, and create the settlement token 160. Here, the TSP 140 may identify the source and the target from the detokenized payment data 142, and lookup the information (IBAN IDs, SWIFT codes, etc.) By linking the payment token to the settlement token 160, a real-time settlement can occur. That is, rather than wait for an overnight settlement process via the payment network 130, the settlement (proof of exchange) can occur on the blockchain settlement network 150 in parallel with the processing going on in the payment network 130.

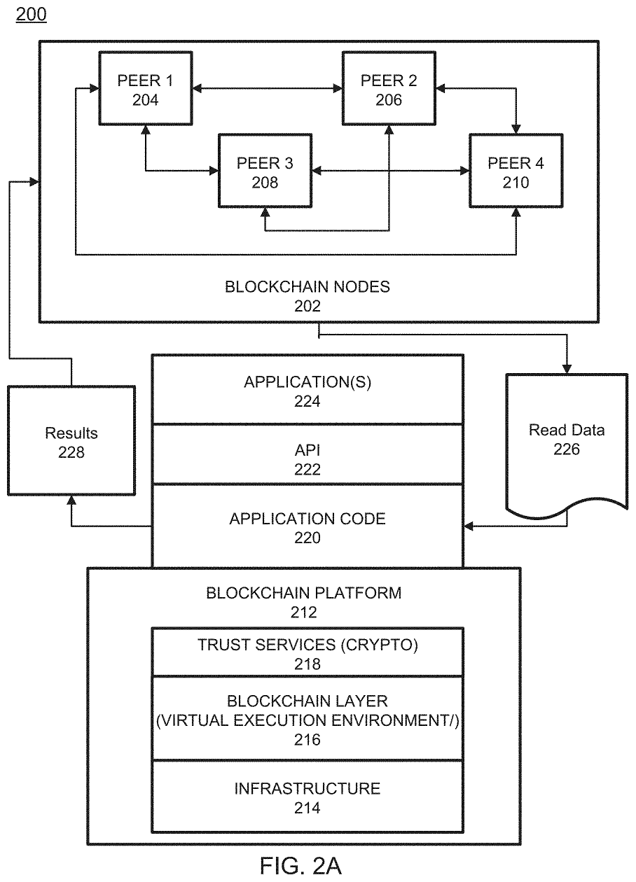

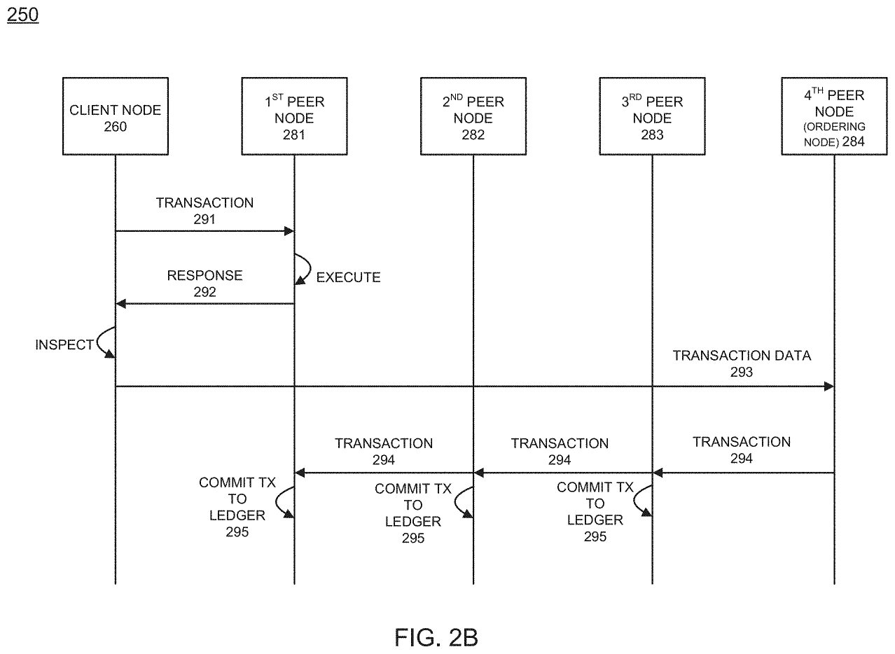

FIG. 2A illustrates a blockchain architecture configuration 200, according to example embodiments. Referring to FIG. 2A, the blockchain architecture 200 may include certain blockchain elements, for example, a group of blockchain nodes 202. The blockchain nodes 202 may include one or more nodes 204-210 (these four nodes are depicted by example only). These nodes participate in a number of activities, such as blockchain transaction addition and validation process (consensus). One or more of the blockchain nodes 204-210 may endorse transactions based on endorsement policy and may provide an ordering service for all blockchain nodes in the architecture 200. A blockchain node may initiate a blockchain authentication and seek to write to a blockchain immutable ledger stored in blockchain layer 216, a copy of which may also be stored on the underpinning physical infrastructure 214. The blockchain configuration may include one or more applications 224 which are linked to application programming interfaces (APIs) 222 to access and execute stored program/application code 220 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2A may process and execute program/application code 220 via one or more interfaces exposed, and services provided, by blockchain platform 212. The code 220 may control blockchain assets. For example, the code 220 can store and transfer data, and may be executed by nodes 204-210 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, the smart contract (or chaincode executing the logic of the smart contract) may read blockchain data 226 which may be processed by one or more processing entities (e.g., virtual machines) included in the blockchain layer 216 to generate results 228 including alerts, determining liability, and the like, within a complex service scenario. The physical infrastructure 214 may be utilized to retrieve any of the data or information described herein.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract logic which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into one or more blocks within the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation (e.g., the logic) of a smart contract. For example, the chaincode may include a packaged and deployable version of the logic within the smart contract. As described herein, the chaincode may be program code deployed on a computing network, where it is executed and validated by chain validators together during a consensus process. The chaincode may receive a hash and retrieve from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details.

FIG. 2B illustrates an example of a blockchain transactional flow 250 between nodes of the blockchain in accordance with an example embodiment. Referring to FIG. 2B, the transaction flow may include a client node 260 transmitting a transaction proposal 291 to an endorsing peer node 281. The endorsing peer 281 may verify the client signature and execute a chaincode function to initiate the transaction. The output may include the chaincode results, a set of key/value versions that were read in the chaincode (read set), and the set of keys/values that were written in chaincode (write set). Here, the endorsing peer 281 may determine whether or not to endorse the transaction proposal. The proposal response 292 is sent back to the client 260 along with an endorsement signature, if approved. The client 260 assembles the endorsements into a transaction payload 293 and broadcasts it to an ordering service node 284. The ordering service node 284 then delivers ordered transactions as blocks to all peers 281-283 on a channel. Before committal to the blockchain, each peer 281-283 may validate the transaction. For example, the peers may check the endorsement policy to ensure that the correct allotment of the specified peers have signed the results and authenticated the signatures against the transaction payload 293.

Referring again to FIG. 2B, the client node initiates the transaction 291 by constructing and sending a request to the peer node 281, which is an endorser. The client 260 may include an application leveraging a supported software development kit (SDK), which utilizes an available API to generate a transaction proposal. The proposal is a request to invoke a chaincode function so that data can be read and/or written to the ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 281 may verify (a) that the transaction proposal is well formed, (b) the transaction has not been submitted already in the past (replay-attack protection), (c) the signature is valid, and (d) that the submitter (client 260, in the example) is properly authorized to perform the proposed operation on that channel. The endorsing peer node 281 may take the transaction proposal inputs as arguments to the invoked chaincode function. The chaincode is then executed against a current state database to produce transaction results including a response value, read set, and write set. However, no updates are made to the ledger at this point. In 292, the set of values, along with the endorsing peer node's 281 signature is passed back as a proposal response 292 to the SDK of the client 260 which parses the payload for the application to consume.

In response, the application of the client 260 inspects/verifies the signatures of the endorsing peers and compares the proposal responses to determine if the proposal response is the same. If the chaincode only queried the ledger, the application would inspect the query response and would typically not submit the transaction to the ordering node service 284. If the client application intends to submit the transaction to the ordering node service 284 to update the ledger, the application determines if the specified endorsement policy has been fulfilled before submitting (i.e., did all peer nodes necessary for the transaction endorse the transaction). Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in step 293 the client 260 assembles endorsements into a transaction proposal and broadcasts the transaction proposal and response within a transaction message to the ordering node 284. The transaction may contain the read/write sets, the endorsing peer signatures and a channel ID. The ordering node 284 does not need to inspect the entire content of a transaction in order to perform its operation, instead the ordering node 284 may simply receive transactions from all channels in the network, order them chronologically by channel, and create blocks of transactions per channel.

The blocks are delivered from the ordering node 284 to all peer nodes 281-283 on the channel. The data section within the block may be validated to ensure an endorsement policy is fulfilled and to ensure that there have been no changes to ledger state for read set variables since the read set was generated by the transaction execution. Furthermore, in step 295 each peer node 281-283 appends the block to the channel's chain, and for each valid transaction the write sets are committed to current state database. An event may be emitted, to notify the client application that the transaction (invocation) has been immutably appended to the chain, as well as to notify whether the transaction was validated or invalidated.

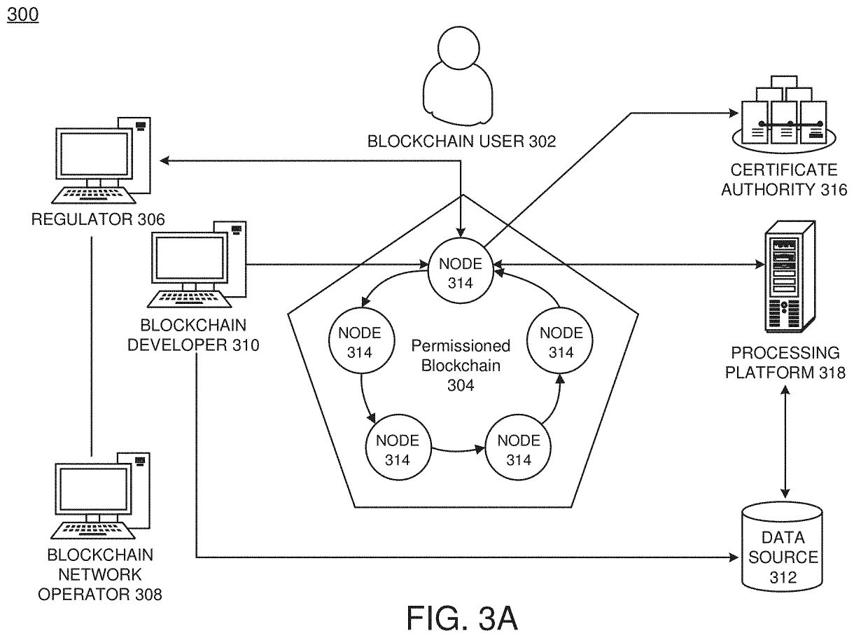

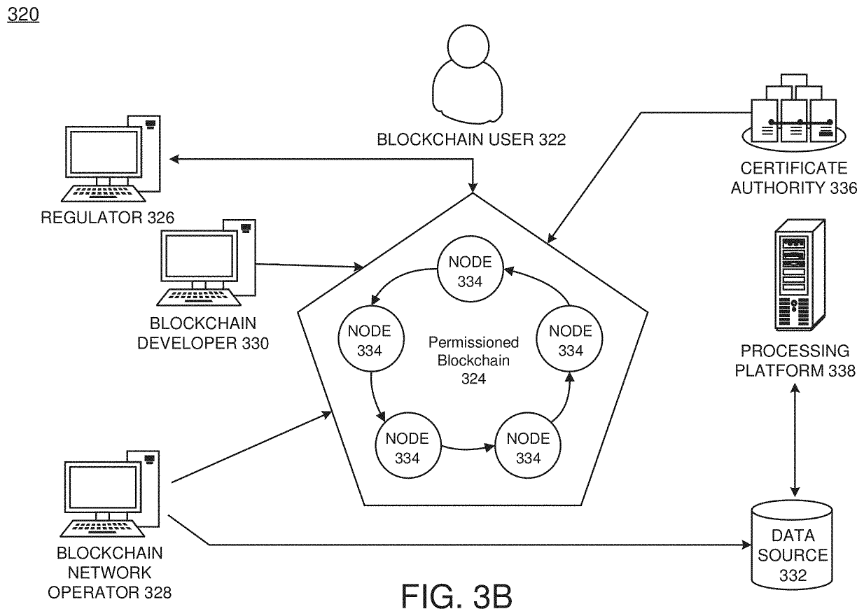

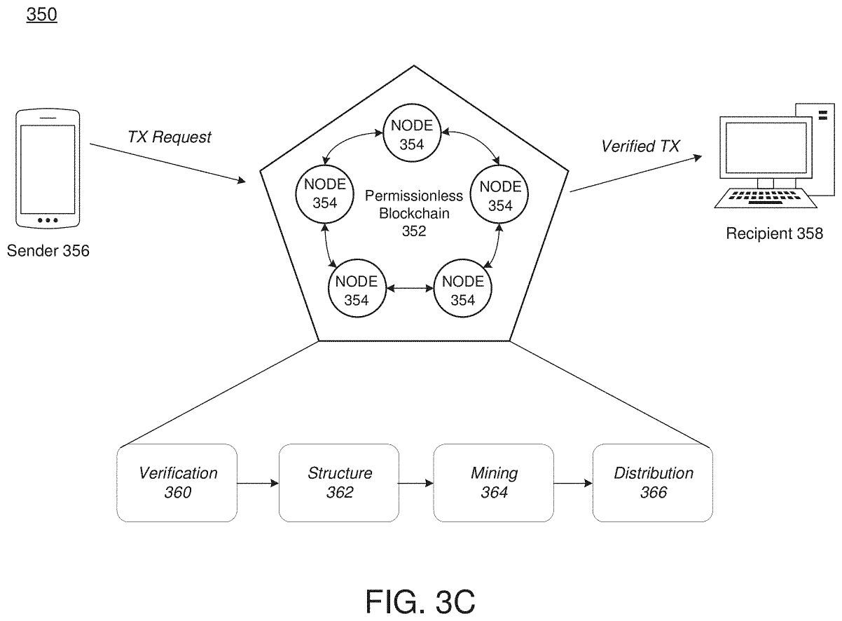

FIG. 3A illustrates an example of a permissioned blockchain network 300, which features a distributed, decentralized peer-to-peer architecture. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client”. An auditor could be restricted only to querying the ledger whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client”. An auditor could be restricted only to querying the ledger whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining protocols to help verify transactions.

FIG. 3C illustrates a process 350 of a transaction being processed by a permissionless blockchain 352 including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters the nodes verify 360 the transaction based on rules (which may be pre-defined or dynamically allocated) established by the permissionless blockchain 352 creators. For example, this may include verifying identities of the parties involved, etc. The transaction may be verified immediately or it may be placed in a queue with other transactions and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256 bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution 366, the successfully validated block is distributed through the permissionless blockchain 352 and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

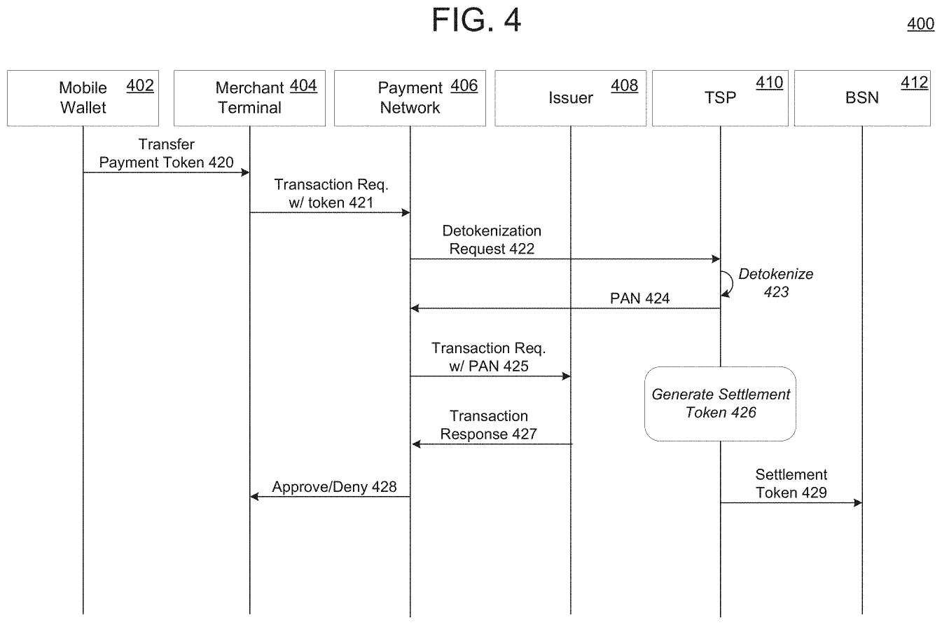

FIG. 4 illustrates a communication process 400 for real-time blockchain settlement of a payment transaction according to example embodiments. Although not shown in FIG. 4, in this example, a user/cardholder owns and operates and mobile device with a mobile wallet 402 installed and running therein. The mobile wallet 402 may include tokenized payment information (payment token) that has been tokenized by a token service provider (TSP) 410. In this process, the TSP 410 may store information about the token such as token ID, information about an issuer of the PAN being tokenized (e.g., issuer ID, MAN ID, SWIFT code, etc.), as well as other details, within a token vault of the TSP 410, which is not shown in FIG. 4. Once included in the mobile wallet 402, the user may use the tokenized payment information to purchase transact.

Referring to FIG. 4, a payment transaction between the user and a merchant may be executed via a merchant terminal 404. For example, the user (cardholder) may use tokenized payment information to make a purchase with the merchant, via the merchant terminal 404. In this example, the user brings a mobile device with a mobile wallet 402 installed therein within a near-field proximity range of the merchant terminal 404 and the tokenized payment information (payment token) is transferred from the mobile wallet 402 on the mobile device to the merchant terminal 404 via a near-field communication message, in 420. The payment token may include a tokenized PAN, a tokenized expiry, and other details of the transaction such as an issuer of the PAN, a wallet ID, a token ID, a token denomination, and the like.

As another example, the payment token may be input into a field of a checkout page on a website. As another example, the payment token may be extracted from a payment card that is inserted into a card reader of the merchant terminal 404 where the payment token is read from the magnetic stripe, electronic chip, etc. of the payment card.

In this example, the merchant terminal transmits the transaction details to an acquiring bank of the merchant (represented by payment network 406), in 421. In response, the payment network 406 transmits a detokenization request to the TSP 410, in 422. Here, the TSP 410 may detokenize the payment token based on mapping information stored in the token vault. In response, the TSP 410 can transmit payment card (PAN, expiry, etc.) to the payment network 406, in 424, for further processing of the transaction. Here, the acquirer (or other entity on the payment network 406) may submit a transaction authorization request to an issuer 408 of the payment card, in 425, and receive an authorization response from the issuer 408, in 427. The authorization response may indicate whether the payment has been authorized or denied, for example, based on funds in the cardholder's account. In 428, the acquirer (payment network 406) transmits the response results (approve/deny) to the merchant terminal to finalize the payment transaction with the user.

According to various embodiments, in parallel with the payment transaction being processed on the payment network 406, the TSP 410 can trigger a settlement process on a blockchain settlement network (BSN) 412 at the same time. In particular, the TSP 410 can extract data from the payment token (including detokenized data) and data of the source (issuer) and the target (acquirer) and input the information into a settlement token, in 426. In other words, the detokenization request 422 from the payment network 406 may simultaneously trigger detokenization of the payment token, and initiating of a settlement process on a separate and independent blockchain settlement network 412. Furthermore, in 429, the TSP 410 may transmit the settlement token to a blockchain peer of the blockchain settlement network 412.

For example, the settlement token may include an MAN ID of the source, an MAN ID of the target, a SWIFT code of the source, a SWIFT code of the target, a token ID of the payment token, a token denomination/value, a token type, an issuing bank identifier, a TSP ID, a token vault ID, a network ID of the payment network 406, and the like. In doing so, the TSP 410 maps the settlement token to the payment token enabling the settlement token to be processed at the same time in a separate network. Thus, real-time settlement on the blockchain settlement network 412 can occur simultaneously or overlapping with the payment process on the payment network 406.

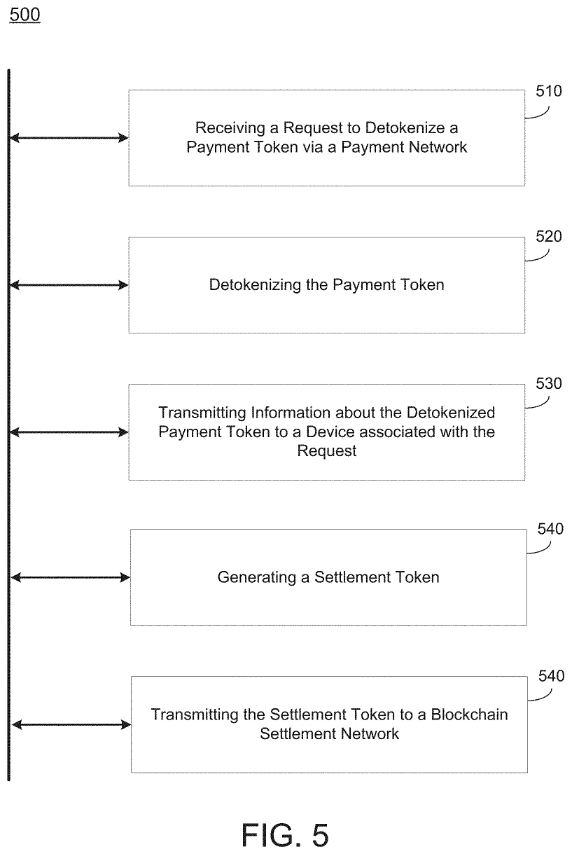

FIG. 5 illustrates a method 500 of real-time blockchain settlement of a payment transaction according to example embodiments. As a non-limiting example, the method 500 may be performed by a token service provider (TSP) that interacts with both a payment network and a blockchain network, however embodiments are not limited thereto. Referring to FIG. 5, in 510, the method may include receiving, via a payment network, a request to detokenize a payment token to process a payment transaction between a source and a target. For example, the request may be received via an entity (e.g., acquirer, payment gateway, payment processor, etc.) of a payment network. The payment token may be an EMV payment token storing transaction details between a consumer (e.g., mobile wallet) and a merchant. The payment token may include encrypted/tokenized card information of the consumer which is provided by the mobile wallet during a payment transaction.

In 520, the method may include detokenizing the payment token based on mapping data stored in a token vault. The detokenizing of the payment token may decrypt the details of the payment card (e.g., PAN, expiry, etc.), and also reveal the transaction details, attributes of the payment token (e.g., type, denomination, etc.). In 530, the method may further include transmitting information about the detokenized payment token to a computing device associated with the request to process the payment transaction via the payment network.

Meanwhile, in 540, the method may also include generating a settlement token that comprises identifiers of the source and the target and an identifier of the payment token. Here, the settlement token may be created while the payment process is being performed (e.g., simultaneously, in parallel, etc.). The settlement token may include details of the payment transaction and the token which are revealed from the detokenization. The settlement token may also include details of a source entity and a target entity of the payment token, which are extracted from a token vault of the token service provider. In 550, the method may include transmitting the settlement token to a blockchain on a blockchain settlement network which is parallel to the payment network. Thus, the settlement of the payment transaction can be performed simultaneously, and in real time, with the payment process being performed on the payment network.

In some embodiments, the generating the settlement token may include mapping a bank identifier of the source, a bank identifier of the target, and a date and time of the payment transaction from the received request into fields within the settlement token. In some embodiments, the generating the settlement token may include mapping a token identifier of an EMV payment token and a token type of the EMV payment token from the payment token into fields within the settlement token. In some embodiments, the generating the settlement token may include inserting an identifier of a token service provider (TSP) and an identifier of the token vault into fields within the settlement token. In some embodiments, the generating the settlement token may include inserting an International Bank Account Number (IBAN) of one or more of the source and the target into fields within the settlement token. In some embodiments, the generating the settlement token may include inserting a Society for Worldwide Interbank Financial Telecommunication (SWIFT) code of one or more of the source and the target into fields within the settlement token. In some embodiments, the transmitting may include transmitting the settlement token to a blockchain peer of the blockchain settlement network.

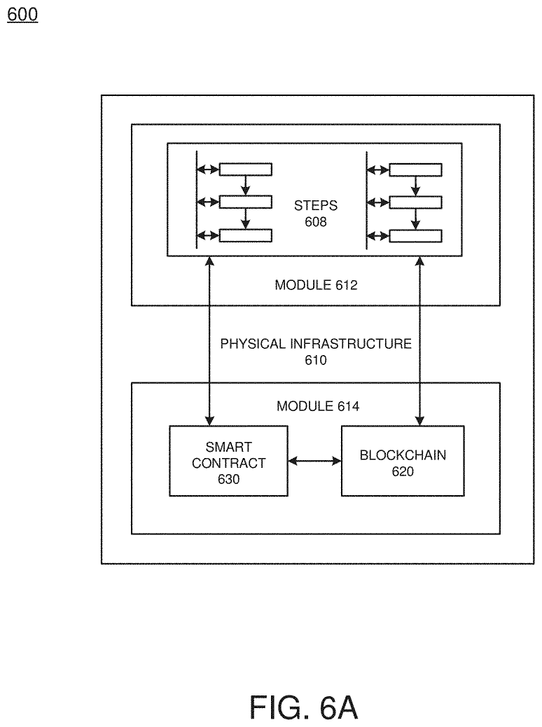

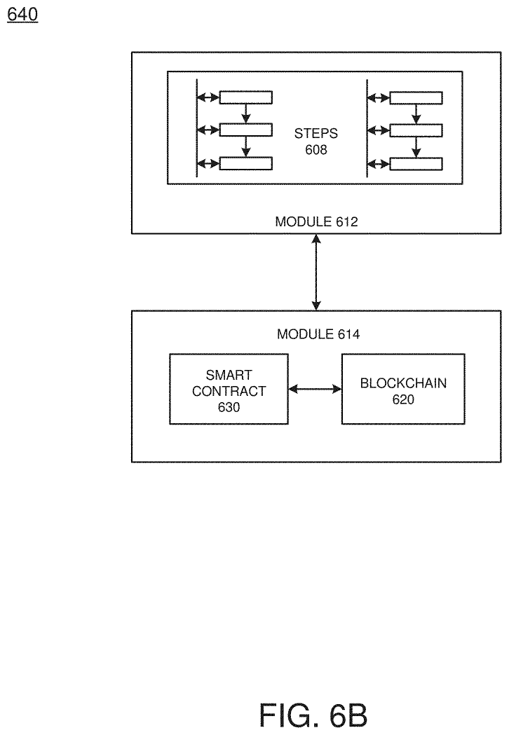

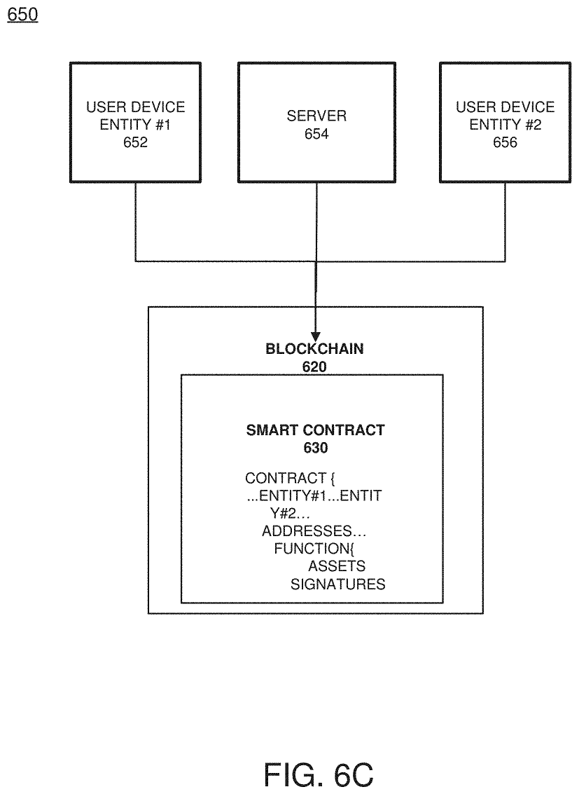

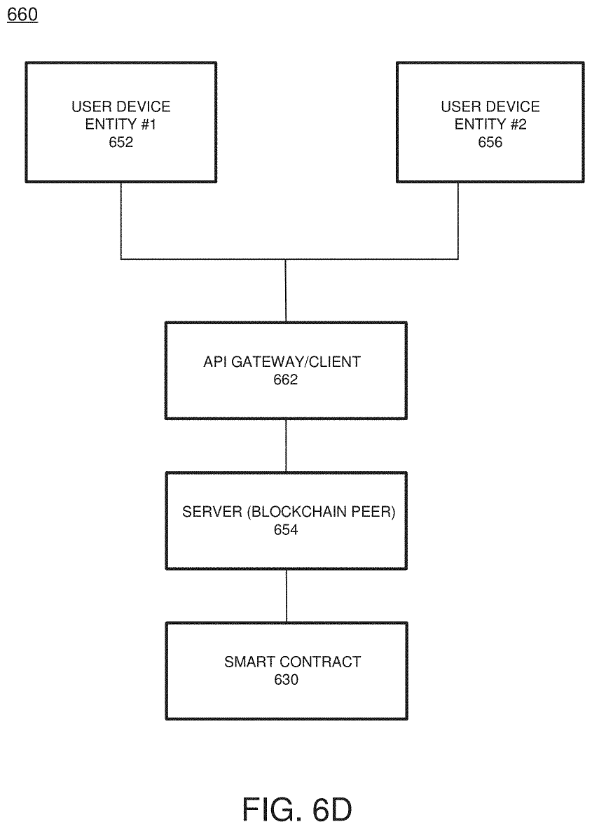

FIG. 6A illustrates an example system 600 that includes a physical infrastructure 610 configured to perform various operations according to example embodiments. Referring to FIG. 6A, the physical infrastructure 610 includes a module 612 and a module 614. The module 614 includes a blockchain 620 and a smart contract 630 (which may reside on the blockchain 620), that may execute any of the operational steps 608 (in module 612) included in any of the example embodiments. The steps/operations 608 may include one or more of the embodiments described or depicted and may represent output or written information that is written or read from one or more smart contracts 630 and/or blockchains 620. The physical infrastructure 610, the module 612, and the module 614 may include one or more computers, servers, processors, memories, and/or wireless communication devices. Further, the module 612 and the module 614 may be a same module.

FIG. 6B illustrates another example system 640 configured to perform various operations according to example embodiments. Referring to FIG. 6B, the system 640 includes a module 612 and a module 614. The module 614 includes a blockchain 620 and a smart contract 630 (which may reside on the blockchain 620), that may execute any of the operational steps 608 (in module 612) included in any of the example embodiments. The steps/operations 608 may include one or more of the embodiments described or depicted and may represent output or written information that is written or read from one or more smart contracts 630 and/or blockchains 620. The physical infrastructure 610, the module 612, and the module 614 may include one or more computers, servers, processors, memories, and/or wireless communication devices. Further, the module 612 and the module 614 may be a same module.

FIG. 6C illustrates an example system configured to utilize a smart contract configuration among contracting parties and a mediating server configured to enforce the smart contract terms on the blockchain according to example embodiments. Referring to FIG. 6C, the configuration 650 may represent a communication session, an asset transfer session or a process or procedure that is driven by a smart contract 630 which explicitly identifies one or more user devices 652 and/or 656. The execution, operations and results of the smart contract execution may be managed by a server 654. Content of the smart contract 630 may require digital signatures by one or more of the entities 652 and 656 which are parties to the smart contract transaction. The results of the smart contract execution may be written to a blockchain 620 as a blockchain transaction. The smart contract 630 resides on the blockchain 620 which may reside on one or more computers, servers, processors, memories, and/or wireless communication devices.

FIG. 6D illustrates a system 660 including a blockchain, according to example embodiments. Referring to the example of FIG. 6D, an application programming interface (API) gateway 662 provides a common interface for accessing blockchain logic (e.g., smart contract 630 or other chaincode) and data (e.g., distributed ledger, etc.). In this example, the API gateway 662 is a common interface for performing transactions (invoke, queries, etc.) on the blockchain by connecting one or more entities 652 and 656 to a blockchain peer (i.e., server 654). Here, the server 654 is a blockchain network peer component that holds a copy of the world state and a distributed ledger allowing clients 652 and 656 to query data on the world state as well as submit transactions into the blockchain network where, depending on the smart contract 630 and endorsement policy, endorsing peers will run the smart contracts 630.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

FIG. 7A illustrates a process 700 of a new block being added to a distributed ledger 720, according to example embodiments, and FIG. 7B illustrates contents of a new data block structure 730 for blockchain, according to example embodiments. Referring to FIG. 7A, clients (not shown) may submit transactions to blockchain nodes 711, 712, and/or 713. Clients may be instructions received from any source to enact activity on the blockchain 720. As an example, clients may be applications that act on behalf of a requester, such as a device, person or entity to propose transactions for the blockchain. The plurality of blockchain peers (e.g., blockchain nodes 711, 712, and 713) may maintain a state of the blockchain network and a copy of the distributed ledger 720. Different types of blockchain nodes/peers may be present in the blockchain network including endorsing peers which simulate and endorse transactions proposed by clients and committing peers which verify endorsements, validate transactions, and commit transactions to the distributed ledger 720. In this example, the blockchain nodes 711, 712, and 713 may perform the role of endorser node, committer node, or both.

The distributed ledger 720 includes a blockchain which stores immutable, sequenced records in blocks, and a state database 724 (current world state) maintaining a current state of the blockchain 722. One distributed ledger 720 may exist per channel and each peer maintains its own copy of the distributed ledger 720 for each channel of which they are a member. The blockchain 722 is a transaction log, structured as hash-linked blocks where each block contains a sequence of N transactions. Blocks may include various components such as shown in FIG. 7B. The linking of the blocks (shown by arrows in FIG. 7A) may be generated by adding a hash of a prior block's header within a block header of a current block. In this way, all transactions on the blockchain 722 are sequenced and cryptographically linked together preventing tampering with blockchain data without breaking the hash links. Furthermore, because of the links, the latest block in the blockchain 722 represents every transaction that has come before it. The blockchain 722 may be stored on a peer file system (local or attached storage), which supports an append-only blockchain workload.

The current state of the blockchain 722 and the distributed ledger 722 may be stored in the state database 724. Here, the current state data represents the latest values for all keys ever included in the chain transaction log of the blockchain 722. Chaincode invocations execute transactions against the current state in the state database 724. To make these chaincode interactions extremely efficient, the latest values of all keys are stored in the state database 724. The state database 724 may include an indexed view into the transaction log of the blockchain 722, it can therefore be regenerated from the chain at any time. The state database 724 may automatically get recovered (or generated if needed) upon peer startup, before transactions are accepted.

Endorsing nodes receive transactions from clients and endorse the transaction based on simulated results. Endorsing nodes hold smart contracts which simulate the transaction proposals. When an endorsing node endorses a transaction, the endorsing nodes creates a transaction endorsement which is a signed response from the endorsing node to the client application indicating the endorsement of the simulated transaction. The method of endorsing a transaction depends on an endorsement policy which may be specified within chaincode. An example of an endorsement policy is “the majority of endorsing peers must endorse the transaction”. Different channels may have different endorsement policies. Endorsed transactions are forward by the client application to ordering service 710.

The ordering service 710 accepts endorsed transactions, orders them into a block, and delivers the blocks to the committing peers. For example, the ordering service 710 may initiate a new block when a threshold of transactions has been reached, a timer times out, or another condition. In the example of FIG. 7A, blockchain node 712 is a committing peer that has received a new data new data block 730 for storage on blockchain 720. The first block in the blockchain may be referred to as a genesis block which includes information about the blockchain, its members, the data stored therein, etc.

The ordering service 710 may be made up of a cluster of orderers. The ordering service 710 does not process transactions, smart contracts, or maintain the shared ledger. Rather, the ordering service 710 may accept the endorsed transactions and specifies the order in which those transactions are committed to the distributed ledger 720. The architecture of the blockchain network may be designed such that the specific implementation of ‘ordering’ (e.g., Solo, Kafka, BFT, etc.) becomes a pluggable component.

Transactions are written to the distributed ledger 720 in a consistent order. The order of transactions is established to ensure that the updates to the state database 724 are valid when they are committed to the network. Unlike a cryptocurrency blockchain system (e.g., Bitcoin, etc.) where ordering occurs through the solving of a cryptographic puzzle, or mining, in this example the parties of the distributed ledger 720 may choose the ordering mechanism that best suits that network.

When the ordering service 710 initializes a new data block 730, the new data block 730 may be broadcast to committing peers (e.g., blockchain nodes 711, 712, and 713). In response, each committing peer validates the transaction within the new data block 730 by checking to make sure that the read set and the write set still match the current world state in the state database 724. Specifically, the committing peer can determine whether the read data that existed when the endorsers simulated the transaction is identical to the current world state in the state database 724. When the committing peer validates the transaction, the transaction is written to the blockchain 722 on the distributed ledger 720, and the state database 724 is updated with the write data from the read-write set. If a transaction fails, that is, if the committing peer finds that the read-write set does not match the current world state in the state database 724, the transaction ordered into a block will still be included in that block, but it will be marked as invalid, and the state database 724 will not be updated.

Referring to FIG. 7B, a new data block 730 (also referred to as a data block) that is stored on the blockchain 722 of the distributed ledger 720 may include multiple data segments such as a block header 740, block data 750 (block data section), and block metadata 760. It should be appreciated that the various depicted blocks and their contents, such as new data block 730 and its contents, shown in FIG. 7B are merely examples and are not meant to limit the scope of the example embodiments. In a conventional block, the data section may store transactional information of N transaction(s) (e.g., 1, 10, 100, 500, 1000, 2000, 3000, etc.) within the block data 750.

The new data block 730 may include a link to a previous block (e.g., on the blockchain 722 in FIG. 7A) within the block header 740. In particular, the block header 740 may include a hash of a previous block's header. The block header 740 may also include a unique block number, a hash of the block data 750 of the new data block 730, and the like. The block number of the new data block 730 may be unique and assigned in various orders, such as an incremental/sequential order starting from zero.

According to various embodiments, the block data 750 may store a settlement token 752 which maps to a payment token (e.g., an EMV payment token) used in a payment process on a payment network. For example, the settlement token 752 may include an identifier of the payment token, identifiers of a source and a target of the payment, SWIFT codes, IBANs, and the like, of the EMV payment token. According to various embodiments, the settlement token 752 can be stored in an immutable log of blocks on the distributed ledger 720. Some of the benefits of storing the settlement token 752 on the blockchain are reflected in the various embodiments disclosed and depicted herein. Although in FIG. 7B, the settlement token 752 is depicted in the block data 750, in other embodiments, the settlement token 752 may be located in the block header 740 or the block metadata 760.

The block metadata 760 may store multiple fields of metadata (e.g., as a byte array, etc.). Metadata fields may include signature on block creation, a reference to a last configuration block, a transaction filter identifying valid and invalid transactions within the block, last offset persisted of an ordering service that ordered the block, and the like. The signature, the last configuration block, and the orderer metadata may be added by the ordering service 710. Meanwhile, a committing node of the block (such as blockchain node 712) may add validity/invalidity information based on an endorsement policy, verification of read/write sets, and the like. The transaction filter may include a byte array of a size equal to the number of transactions that are included in the block data 750 and a validation code identifying whether a transaction was valid/invalid.

FIG. 7C illustrates an embodiment of a blockchain 770 for digital content in accordance with the embodiments described herein. The digital content may include one or more files and associated information. The files may include media, images, video, audio, text, links, graphics, animations, web pages, documents, or other forms of digital content. The immutable, append-only aspects of the blockchain serve as a safeguard to protect the integrity, validity, and authenticity of the digital content, making it suitable use in legal proceedings where admissibility rules apply or other settings where evidence is taken into consideration or where the presentation and use of digital information is otherwise of interest. In this case, the digital content may be referred to as digital evidence.

The blockchain may be formed in various ways. In one embodiment, the digital content may be included in and accessed from the blockchain itself. For example, each block of the blockchain may store a hash value of reference information (e.g., header, value, etc.) along the associated digital content. The hash value and associated digital content may then be encrypted together. Thus, the digital content of each block may be accessed by decrypting each block in the blockchain, and the hash value of each block may be used as a basis to reference a previous block. This may be illustrated as follows:

| Block 1 | Block 2 | . . . | Block N |
|---|---|---|---|
| Hash Value 1 | Hash Value 2 | | Hash Value N |
| Digital Content 1 | Digital Content 2 | | Digital Content N |

In one embodiment, the digital content may be not included in the blockchain. For example, the blockchain may store the encrypted hashes of the content of each block without any of the digital content. The digital content may be stored in another storage area or memory address in association with the hash value of the original file. The other storage area may be the same storage device used to store the blockchain or may be a different storage area or even a separate relational database. The digital content of each block may be referenced or accessed by obtaining or querying the hash value of a block of interest and then looking up that has value in the storage area, which is stored in correspondence with the actual digital content. This operation may be performed, for example, a database gatekeeper. This may be illustrated as follows:

| Blockchain | Storage Area |
|---|---|
| Block 1 Hash Value | Block 1 Hash Value . . . Content |
| . | . |
| . | . |
| . | . |
| Block N Hash Value | Block N Hash Value . . . Content |

In the example embodiment of FIG. 7C, the blockchain 770 includes a number of blocks 778₁, 778₂, . . . 778_{N} cryptographically linked in an ordered sequence, where N≥1. The encryption used to link the blocks 778₁, 778₂, . . . 778_{N} may be any of a number of keyed or un-keyed Hash functions. In one embodiment, the blocks 778₁, 778₂, . . . 778_{N} are subject to a hash function which produces n-bit alphanumeric outputs (where n is 256 or another number) from inputs that are based on information in the blocks. Examples of such a hash function include, but are not limited to, a SHA-type (SHA stands for Secured Hash Algorithm) algorithm, Merkle-Damgard algorithm, HAIFA algorithm, Merkle-tree algorithm, nonce-based algorithm, and a non-collision-resistant PRF algorithm. In another embodiment, the blocks 778₁, 778₂, . . . , 778_{N} may be cryptographically linked by a function that is different from a hash function. For purposes of illustration, the following description is made with reference to a hash function, e.g., SHA-2.

Each of the blocks 778₁, 778₂, . . . , 778_{N} in the blockchain includes a header, a version of the file, and a value. The header and the value are different for each block as a result of hashing in the blockchain. In one embodiment, the value may be included in the header. As described in greater detail below, the version of the file may be the original file or a different version of the original file.

The first block 778₁ in the blockchain is referred to as the genesis block and includes the header 772₁, original file 774₁, and an initial value 776₁. The hashing scheme used for the genesis block, and indeed in all subsequent blocks, may vary. For example, all the information in the first block 778₁ may be hashed together and at one time, or each or a portion of the information in the first block 778₁ may be separately hashed and then a hash of the separately hashed portions may be performed.

The header 772₁ may include one or more initial parameters, which, for example, may include a version number, timestamp, nonce, root information, difficulty level, consensus protocol, duration, media format, source, descriptive keywords, and/or other information associated with original file 774₁ and/or the blockchain. The header 772₁ may be generated automatically (e.g., by blockchain network managing software) or manually by a blockchain participant. Unlike the header in other blocks 778₂ to 778_{N} in the blockchain, the header 772₁ in the genesis block does not reference a previous block, simply because there is no previous block.

The original file 774₁ in the genesis block may be, for example, data as captured by a device with or without processing prior to its inclusion in the blockchain. The original file 774₁ is received through the interface of the system from the device, media source, or node. The original file 774₁ is associated with metadata, which, for example, may be generated by a user, the device, and/or the system processor, either manually or automatically. The metadata may be included in the first block 778₁ in association with the original file 774₁.

The value 776₁ in the genesis block is an initial value generated based on one or more unique attributes of the original file 774₁. In one embodiment, the one or more unique attributes may include the hash value for the original file 774₁, metadata for the original file 774₁, and other information associated with the file. In one implementation, the initial value 776₁ may be based on the following unique attributes:
1) SHA-2 computed hash value for the original file
2) originating device ID
3) starting timestamp for the original file
4) initial storage location of the original file
5) blockchain network member ID for software to currently control the original file and associated metadata

The other blocks 778₂ to 778_{N} in the blockchain also have headers, files, and values. However, unlike the first block 772₁, each of the headers 772₂ to 772_{N} in the other blocks includes the hash value of an immediately preceding block. The hash value of the immediately preceding block may be just the hash of the header of the previous block or may be the hash value of the entire previous block. By including the hash value of a preceding block in each of the remaining blocks, a trace can be performed from the Nth block back to the genesis block (and the associated original file) on a block-by-block basis, as indicated by arrows 780, to establish an auditable and immutable chain-of-custody.

Each of the header 772₂ to 772_{N} in the other blocks may also include other information, e.g., version number, timestamp, nonce, root information, difficulty level, consensus protocol, and/or other parameters or information associated with the corresponding files and/or the blockchain in general.

The files 7742 to 774N in the other blocks may be equal to the original file or may be a modified version of the original file in the genesis block depending, for example, on the type of processing performed. The type of processing performed may vary from block to block. The processing may involve, for example, any modification of a file in a preceding block, such as redacting information or otherwise changing the content of, taking information away from, or adding or appending information to the files.

Additionally, or alternatively, the processing may involve merely copying the file from a preceding block, changing a storage location of the file, analyzing the file from one or more preceding blocks, moving the file from one storage or memory location to another, or performing action relative to the file of the blockchain and/or its associated metadata. Processing which involves analyzing a file may include, for example, appending, including, or otherwise associating various analytics, statistics, or other information associated with the file.

The values in each of the other blocks 7762 to 776N in the other blocks are unique values and are all different as a result of the processing performed. For example, the value in any one block corresponds to an updated version of the value in the previous block. The update is reflected in the hash of the block to which the value is assigned. The values of the blocks therefore provide an indication of what processing was performed in the blocks and also permit a tracing through the blockchain back to the original file. This tracking confirms the chain-of-custody of the file throughout the entire blockchain.

For example, consider the case where portions of the file in a previous block are redacted, blocked out, or pixelated in order to protect the identity of a person shown in the file. In this case, the block including the redacted file will include metadata associated with the redacted file, e.g., how the redaction was performed, who performed the redaction, timestamps where the redaction(s) occurred, etc. The metadata may be hashed to form the value. Because the metadata for the block is different from the information that was hashed to form the value in the previous block, the values are different from one another and may be recovered when decrypted.

In one embodiment, the value of a previous block may be updated (e.g., a new hash value computed) to form the value of a current block when any one or more of the following occurs. The new hash value may be computed by hashing all or a portion of the information noted below, in this example embodiment.
a) new SHA-2 computed hash value if the file has been processed in any way (e.g., if the file was redacted, copied, altered, accessed, or some other action was taken)
b) new storage location for the file
c) new metadata identified associated with the file
d) transfer of access or control of the file from one blockchain participant to another blockchain participant

FIG. 7D illustrates an embodiment of a block which may represent the structure of the blocks in the blockchain 790 in accordance with one embodiment. The block, Blockᵢ, includes a header 772ᵢ, a file 774ᵢ, and a value 776ᵢ.

The header 772ᵢ includes a hash value of a previous block Blockᵢ₋₁ and additional reference information, which, for example, may be any of the types of information (e.g., header information including references, characteristics, parameters, etc.) discussed herein. All blocks reference the hash of a previous block except, of course, the genesis block. The hash value of the previous block may be just a hash of the header in the previous block or a hash of all or a portion of the information in the previous block, including the file and metadata.

The file 774ᵢ includes a plurality of data, such as Data 1, Data 2, . . . , Data N in sequence. The data are tagged with Metadata 1, Metadata 2, . . . , Metadata N which describe the content and/or characteristics associated with the data. For example, the metadata for each data may include information to indicate a timestamp for the data, process the data, keywords indicating the persons or other content depicted in the data, and/or other features that may be helpful to establish the validity and content of the file as a whole, and particularly its use a digital evidence, for example, as described in connection with an embodiment discussed below. In addition to the metadata, each data may be tagged with reference REF₁, REF₂, . . . , REF_{N} to a previous data to prevent tampering, gaps in the file, and sequential reference through the file.

Once the metadata is assigned to the data (e.g., through a smart contract), the metadata cannot be altered without the hash changing, which can easily be identified for invalidation. The metadata, thus, creates a data log of information that may be accessed for use by participants in the blockchain.

The value 776ᵢ is a hash value or other value computed based on any of the types of information previously discussed. For example, for any given block Blockᵢ, the value for that block may be updated to reflect the processing that was performed for that block, e.g., new hash value, new storage location, new metadata for the associated file, transfer of control or access, identifier, or other action or information to be added. Although the value in each block is shown to be separate from the metadata for the data of the file and header, the value may be based, in part or whole, on this metadata in another embodiment.

Once the blockchain 770 is formed, at any point in time, the immutable chain-of-custody for the file may be obtained by querying the blockchain for the transaction history of the values across the blocks. This query, or tracking procedure, may begin with decrypting the value of the block that is most currently included (e.g., the last (N^{th}) block), and then continuing to decrypt the value of the other blocks until the genesis block is reached and the original file is recovered. The decryption may involve decrypting the headers and files and associated metadata at each block, as well.

Decryption is performed based on the type of encryption that took place in each block. This may involve the use of private keys, public keys, or a public key-private key pair. For example, when asymmetric encryption is used, blockchain participants or a processor in the network may generate a public key and private key pair using a predetermined algorithm. The public key and private key are associated with each other through some mathematical relationship. The public key may be distributed publicly to serve as an address to receive messages from other users, e.g., an IP address or home address. The private key is kept secret and used to digitally sign messages sent to other blockchain participants. The signature is included in the message so that the recipient can verify using the public key of the sender. This way, the recipient can be sure that only the sender could have sent this message.

Generating a key pair may be analogous to creating an account on the blockchain, but without having to actually register anywhere. Also, every transaction that is executed on the blockchain is digitally signed by the sender using their private key. This signature ensures that only the owner of the account can track and process (if within the scope of permission determined by a smart contract) the file of the blockchain.

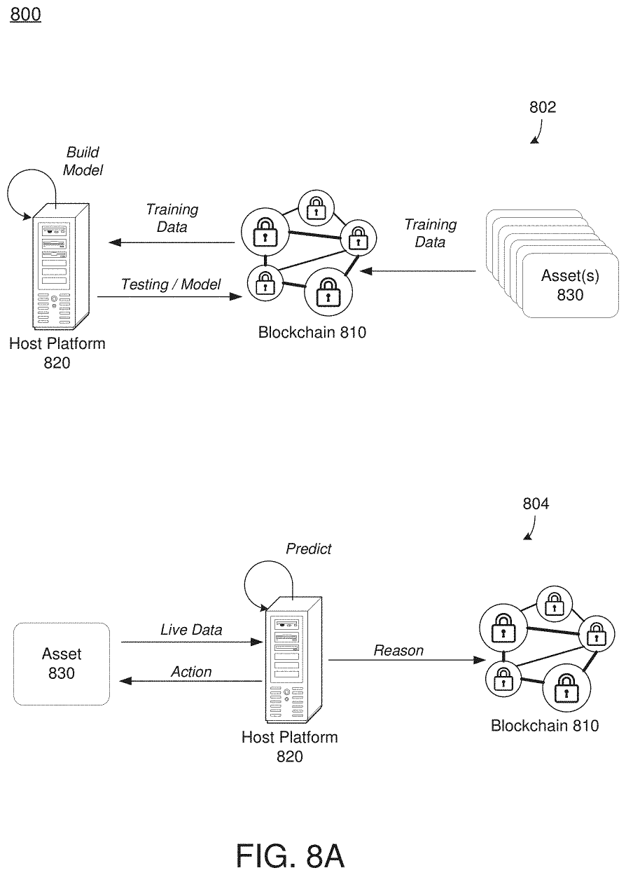

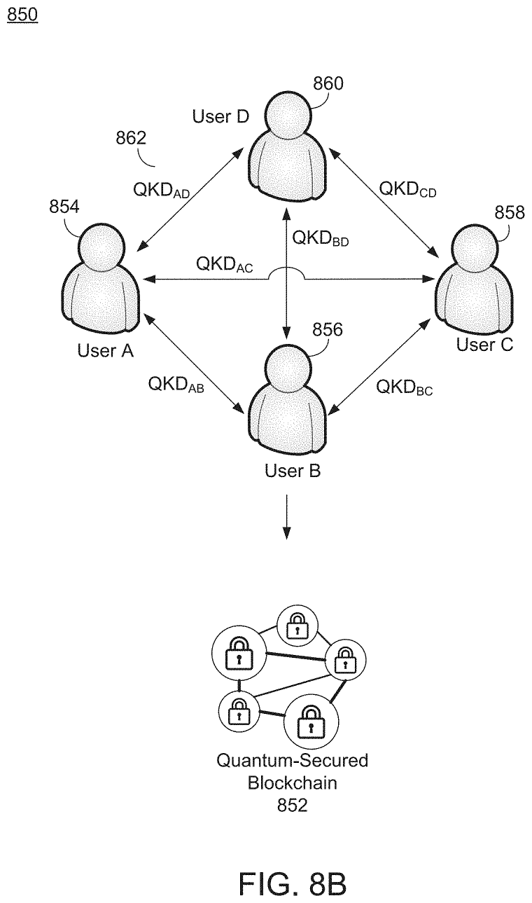

FIGS. 8A and 8B illustrate additional examples of use cases for blockchain which may be incorporated and used herein. In particular, FIG. 8A illustrates an example 800 of a blockchain 810 which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 8A, a host platform 820 builds and deploys a machine learning model for predictive monitoring of assets 830. Here, the host platform 820 may be a cloud platform, an industrial server, a web server, a personal computer, a user device, and the like. Assets 830 can be any type of asset (e.g., machine or equipment, etc.) such as an aircraft, locomotive, turbine, medical machinery and equipment, oil and gas equipment, boats, ships, vehicles, and the like. As another example, assets 830 may be non-tangible assets such as stocks, currency, digital coins, insurance, or the like.

The blockchain 810 can be used to significantly improve both a training process 802 of the machine learning model and a predictive process 804 based on a trained machine learning model. For example, in 802, rather than requiring a data scientist/engineer or other user to collect the data, historical data may be stored by the assets 830 themselves (or through an intermediary, not shown) on the blockchain 810. This can significantly reduce the collection time needed by the host platform 820 when performing predictive model training. For example, using smart contracts, data can be directly and reliably transferred straight from its place of origin to the blockchain 810. By using the blockchain 810 to ensure the security and ownership of the collected data, smart contracts may directly send the data from the assets to the individuals that use the data for building a machine learning model. This allows for sharing of data among the assets 830.

The collected data may be stored in the blockchain 810 based on a consensus mechanism. The consensus mechanism pulls in (permissioned nodes) to ensure that the data being recorded is verified and accurate. The data recorded is time-stamped, cryptographically signed, and immutable. It is therefore auditable, transparent, and secure. Adding IoT devices which write directly to the blockchain can, in certain cases (i.e. supply chain, healthcare, logistics, etc.), increase both the frequency and accuracy of the data being recorded.

Furthermore, training of the machine learning model on the collected data may take rounds of refinement and testing by the host platform 820. Each round may be based on additional data or data that was not previously considered to help expand the knowledge of the machine learning model. In 802, the different training and testing steps (and the data associated therewith) may be stored on the blockchain 810 by the host platform 820. Each refinement of the machine learning model (e.g., changes in variables, weights, etc.) may be stored on the blockchain 810. This provides verifiable proof of how the model was trained and what data was used to train the model. Furthermore, when the host platform 820 has achieved a finally trained model, the resulting model may be stored on the blockchain 810.

After the model has been trained, it may be deployed to a live environment where it can make predictions/decisions based on the execution of the final trained machine learning model. For example, in 804, the machine learning model may be used for condition-based maintenance (CBM) for an asset such as an aircraft, a wind turbine, a healthcare machine, and the like. In this example, data fed back from the asset 830 may be input the machine learning model and used to make event predictions such as failure events, error codes, and the like. Determinations made by the execution of the machine learning model at the host platform 820 may be stored on the blockchain 810 to provide auditable/verifiable proof. As one non-limiting example, the machine learning model may predict a future breakdown/failure to a part of the asset 830 and create alert or a notification to replace the part. The data behind this decision may be stored by the host platform 820 on the blockchain 810. In one embodiment the features and/or the actions described and/or depicted herein can occur on or with respect to the blockchain 810.

New transactions for a blockchain can be gathered together into a new block and added to an existing hash value. This is then encrypted to create a new hash for the new block. This is added to the next list of transactions when they are encrypted, and so on. The result is a chain of blocks that each contain the hash values of all preceding blocks. Computers that store these blocks regularly compare their hash values to ensure that they are all in agreement. Any computer that does not agree, discards the records that are causing the problem. This approach is good for ensuring tamper-resistance of the blockchain, but it is not perfect.

One way to game this system is for a dishonest user to change the list of transactions in their favor, but in a way that leaves the hash unchanged. This can be done by brute force, in other words by changing a record, encrypting the result, and seeing whether the hash value is the same. And if not, trying again and again and again until it finds a hash that matches. The security of blockchains is based on the belief that ordinary computers can only perform this kind of brute force attack over time scales that are entirely impractical, such as the age of the universe. By contrast, quantum computers are much faster (1000s of times faster) and consequently pose a much greater threat.

FIG. 8B illustrates an example 850 of a quantum-secure blockchain 852 which implements quantum key distribution (QKD) to protect against a quantum computing attack. In this example, blockchain users can verify each other's identities using QKD. This sends information using quantum particles such as photons, which cannot be copied by an eavesdropper without destroying them. In this way, a sender and a receiver through the blockchain can be sure of each other's identity.

In the example of FIG. 8B, four users are present 854, 856, 858, and 860. Each of pair of users may share a secret key 862 (i.e., a QKD) between themselves. Since there are four nodes in this example, six pairs of nodes exists, and therefore six different secret keys 862 are used including QKD_{AB}, QKD_{AC}, QKD_{AD}, QKD_{BC}, QKD_{BD}, and QKD_{CD}. Each pair can create a QKD by sending information using quantum particles such as photons, which cannot be copied by an eavesdropper without destroying them. In this way, a pair of users can be sure of each other's identity.

The operation of the blockchain 852 is based on two procedures (i) creation of transactions, and (ii) construction of blocks that aggregate the new transactions. New transactions may be created similar to a traditional blockchain network. Each transaction may contain information about a sender, a receiver, a time of creation, an amount (or value) to be transferred, a list of reference transactions that justifies the sender has funds for the operation, and the like. This transaction record is then sent to all other nodes where it is entered into a pool of unconfirmed transactions. Here, two parties (i.e., a pair of users from among 854-860) authenticate the transaction by providing their shared secret key 862 (QKD). This quantum signature can be attached to every transaction making it exceedingly difficult to tamper with. Each node checks their entries with respect to a local copy of the blockchain 852 to verify that each transaction has sufficient funds. However, the transactions are not yet confirmed.

Rather than perform a traditional mining process on the blocks, the blocks may be created in a decentralized manner using a broadcast protocol. At a predetermined period of time (e.g., seconds, minutes, hours, etc.) the network may apply the broadcast protocol to any unconfirmed transaction thereby to achieve a Byzantine agreement (consensus) regarding a correct version of the transaction. For example, each node may possess a private value (transaction data of that particular node). In a first round, nodes transmit their private values to each other. In subsequent rounds, nodes communicate the information they received in the previous round from other nodes. Here, honest nodes are able to create a complete set of transactions within a new block. This new block can be added to the blockchain 852. In one embodiment the features and/or the actions described and/or depicted herein can occur on or with respect to the blockchain 852.

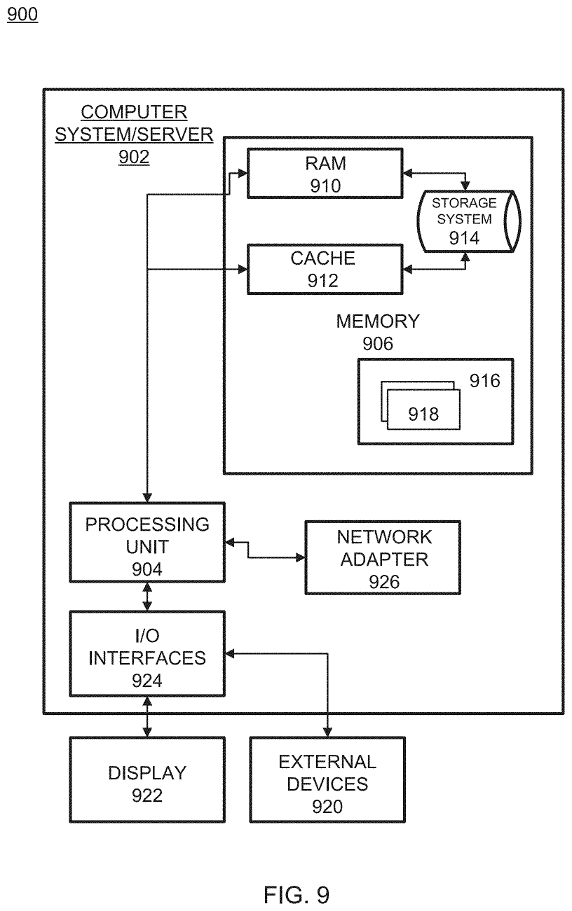

FIG. 9 illustrates an example system 900 that supports one or more of the example embodiments described and/or depicted herein. The system 900 comprises a computer system/server 902, which is operational with numerous other general purpose or special purpose computing system environments or configurations. Examples of well-known computing systems, environments, and/or configurations that may be suitable for use with computer system/server 902 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 902 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 902 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 902 in cloud computing node 900 is shown in the form of a general-purpose computing device. The components of computer system/server 902 may include, but are not limited to, one or more processors or processing units 904, a system memory 906, and a bus that couples various system components including system memory 906 to processor 904.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 902 typically includes a variety of computer system readable media. Such media may be any available media that is accessible by computer system/server 902, and it includes both volatile and non-volatile media, removable and non-removable media. System memory 906, in one embodiment, implements the flow diagrams of the other figures. The system memory 906 can include computer system readable media in the form of volatile memory, such as random-access memory (RAM) 910 and/or cache memory 912. Computer system/server 902 may further include other removable/non-removable, volatile/non-volatile computer system storage media. By way of example only, storage system 914 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 906 may include at least one program product having a set (e.g., at least one) of program modules that are configured to carry out the functions of various embodiments of the application.

Program/utility 916, having a set (at least one) of program modules 918, may be stored in memory 906 by way of example, and not limitation, as well as an operating system, one or more application programs, other program modules, and program data. Each of the operating system, one or more application programs, other program modules, and program data or some combination thereof, may include an implementation of a networking environment. Program modules 918 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 902 may also communicate with one or more external devices 920 such as a keyboard, a pointing device, a display 922, etc.; one or more devices that enable a user to interact with computer system/server 902; and/or any devices (e.g., network card, modem, etc.) that enable computer system/server 902 to communicate with one or more other computing devices. Such communication can occur via I/O interfaces 924. Still yet, computer system/server 902 can communicate with one or more networks such as a local area network (LAN), a general wide area network (WAN), and/or a public network (e.g., the Internet) via network adapter 926. As depicted, network adapter 926 communicates with the other components of computer system/server 902 via a bus. It should be understood that although not shown, other hardware and/or software components could be used in conjunction with computer system/server 902. Examples include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

1. An apparatus comprising:
a processor configured to generate a payment-enabled token for a payment network that replaces a payment account number and store a mapping between the payment-enabled token and the payment account number via a token vault; and
a network interface configured to receive, via the payment network, a payment authorization request message that includes the payment-enabled token for processing a payment transaction between a source and a target,
wherein the processor is further configured to
detokenize the payment-enabled token to reveal the payment account number based on the mapping stored in the token vault,
transmit the detokenized payment account number to a payment network computing device associated with the request to trigger a payment process;
generate a settlement token via the token vault which comprises identifiers of the source of the payment-enabled token, the target of the payment-enabled token, and the payment-enabled token of the payment network stored therein, and
trigger a settlement process in parallel and simultaneously with the payment process via transmission of the settlement token to a blockchain on a blockchain settlement network which is disposed independently from the payment network.

2. The apparatus of claim 1, wherein the processor is configured to insert a bank identifier of the source, a bank identifier of the target, and a date and time of the payment transaction from the received request into predetermined fields within a storage structure of the settlement token.

3. The apparatus of claim 1, wherein the processor is configured to insert a token denomination and a token type of the payment token from the payment token into predetermined fields within a storage structure of the settlement token.

4. The apparatus of claim 1, wherein the processor is configured to insert an identifier of a token service provider (TSP) and an identifier of the token vault into predetermined fields within a storage structure of the settlement token.

5. The apparatus of claim 1, wherein the processor is configured to insert an International Bank Account Number (IBAN) of one or more of the source and the target into predetermined fields within a storage structure of the settlement token.

6. The apparatus of claim 1, wherein the processor is configured to insert a Society for Worldwide Interbank Financial Telecommunication (SWIFT) code of one or more of the source and the target into predetermined fields within a storage structure of the settlement token.

7. The apparatus of claim 1, wherein the processor is configured to transmit the settlement token to a blockchain peer of the blockchain settlement network.

8. A method comprising:
generating a payment-enabled token for a payment network that replaces a payment account number and storing a mapping between the payment-enabled token and the payment account number via a token vault;
receiving, via the payment network, a payment authorization request message that includes the payment-enabled token for processing a payment transaction between a source and a target;
detokenizing the payment-enabled token to reveal the payment account number based on the mapping stored in the token vault;
transmitting the detokenized payment account number to a payment network computing device associated with the request to trigger a payment process;
generating a settlement token via the token vault which comprises identifiers of the source of the payment-enabled token, the target of the payment-enabled token, and the payment-enabled token of the payment network stored therein; and
triggering a settlement process in parallel and simultaneously with the payment process via transmission of the settlement token to a blockchain on a blockchain settlement network which is disposed independently from the payment network.

9. The method of claim 8, wherein the generating the settlement token comprises inserting a bank identifier of the source, a bank identifier of the target, and a date and time of the payment transaction from the received request into predetermined fields within a storage structure of the settlement token.

10. The method of claim 8, wherein the generating the settlement token comprises inserting a token identifier of an EMV payment token and a token type of the EMV payment token from the payment token into predetermined fields within a storage structure of the settlement token.

11. The method of claim 8, wherein the generating the settlement token comprises inserting an identifier of a token service provider (TSP) and an identifier of the token vault into predetermined fields within a storage structure of the settlement token.

12. The method of claim 8, wherein the generating the settlement token comprises inserting an International Bank Account Number (IBAN) of one or more of the source and the target into predetermined fields within a storage structure of the settlement token.

13. The method of claim 8, wherein the generating the settlement token comprises inserting a Society for Worldwide Interbank Financial Telecommunication (SWIFT) code of one or more of the source and the target into predetermined fields within a storage structure of the settlement token.

14. The method of claim 8, wherein the transmitting comprises transmitting the settlement token to a blockchain peer of the blockchain settlement network.

15. A non-transitory computer-readable medium comprising instructions, that when read by a processor, cause the processor to perform a method comprising:
generating a payment-enabled token for a payment network that replaces a payment account number and storing a mapping between the payment-enabled token and the payment account number via a token vault;
receiving, via the payment network, a payment authorization request message that includes the payment-enabled token for processing a payment transaction between a source and a target;
detokenizing the payment-enabled token to reveal the payment account number based on the mapping stored in the token vault;
transmitting the detokenized payment token account number to a payment network computing device associated with the request to trigger a payment process;
generating a settlement token via the token vault which comprises identifiers of the source of the payment-enabled token, the target of the payment-enabled token, and the payment-enabled token of the payment network stored therein; and
triggering a settlement process in parallel and simultaneously with the payment process via transmission of the settlement token to a blockchain on a blockchain settlement network which is disposed independently from the payment network.

16. The non-transitory computer-readable medium of claim 15, wherein the generating the settlement token comprises inserting a bank identifier of the source of the payment-enabled token, a bank identifier of the target of the payment-enabled token, and a date and time of the payment transaction from the received request into predetermined fields within a storage structure of the settlement token.

17. The non-transitory computer-readable medium of claim 15, wherein the generating the settlement token comprises inserting a token identifier of an EMV payment token and a token type of the EMV payment token of the payment token into predetermined fields within a storage structure of the settlement token.

18. The non-transitory computer-readable medium of claim 15, wherein the generating the settlement token comprises inserting an identifier of a token service provider (TSP) and an identifier of the token vault into predetermined fields within a storage structure of the settlement token.

19. The non-transitory computer-readable medium of claim 15, wherein the generating the settlement token comprises inserting an International Bank Account Number (IBAN) of one or more of the source and the target into predetermined fields within a storage structure of the settlement token.

20. The non-transitory computer-readable medium of claim 15, wherein the generating the settlement token comprises inserting a Society for Worldwide Interbank Financial Telecommunication (SWIFT) code of one or more of the source and the target into predetermined fields within a storage structure of the settlement token.
